(19) United States
(12) Patent Application Publication
(10) Pub. No.: US 2026/0010043 A1
(43) Pub. Date: Jan. 8, 2026

(54) DISPLAY DEVICE

(71) Applicant: Japan Display Inc., Tokyo (JP)

(72) Inventors: Hiroyuki ABE, Tokyo (JP); Akihiko SAITOH, Tokyo (JP)

(73) Assignee: Japan Display Inc., Tokyo (JP)

(21) Appl. No.: 19/223,112

(22) Filed: May 30, 2025

(30) Foreign Application Priority Data
Jul. 4, 2024 (JP) 2024-108071

(51) Int. Cl. G02F 1/1362; G02F 1/1368

(52) U.S. Cl. CPC G02F 1/136286; G02F 1/1368

(57) ABSTRACT

A display device includes a substrate, a gate-line driver circuit, a signal-line driver circuit, a plurality of gate lines, and a plurality of image-signal lines. The substrate has a display region having a polygonal shape with n vertices and arranged with a plurality of pixels as well as a frame region surrounding the display region. The gate-line driver circuit and the signal-line driver circuit are located over the frame region. The plurality of gate lines extends from the gate-line driver circuit to the display region. The plurality of image-signal lines extends from the signal-line driver circuit to the display region and intersects the plurality of gate lines. Each of the plurality of pixels includes a transistor having a first gate electrode, a semiconductor film over the first gate electrode, and a second gate electrode over the semiconductor film. Other features are described in the specification in detail.

### CROSS-REFERENCE TO RELATED APPLICATIONS

This application claims the benefit of priority to Japanese Patent Application No. 2024-108071, filed on Jul. 4, 2024, the entire contents of which are incorporated herein by reference.

### FIELD

An embodiment of the present invention relates to a display device. For example, an embodiment of the present invention relates to a display device which can be also applied to high-resolution small display devices utilized for VR (virtual reality) goggles and the like.

### BACKGROUND

With the recent technological development of liquid crystal displays and electroluminescence displays, extremely high resolution display devices have been launched in the market. An application of high-resolution display devices is VR goggles worn on the user's head. Unlike display devices with rectangular display regions used in smartphones and TV monitors, many display devices used in VR goggles have display regions with a nearly circular shape in order to simulate human vision. For example, display devices with a display region whose outline is partially composed of curved lines or an octagonal display region are disclosed in Japanese Laid-Open Patent Application No. 2024-7220 and Japanese Patent No. 6639866. A display region which is not rectangular is also called an irregularly shaped display region.

### SUMMARY

An embodiment of the present invention is a display device. The display device includes a substrate, a gate-line driver circuit, a signal-line driver circuit, a plurality of gate lines, and a plurality of image-signal lines. The substrate has a display region having a polygonal shape with n vertices and arranged with a plurality of pixels as well as a frame region surrounding the display region. The gate-line driver circuit and the signal-line driver circuit are located over the frame region. The plurality of gate lines extends from the gate-line driver circuit to the display region. The plurality of image-signal lines extends from the signal-line driver circuit to the display region and intersects the plurality of gate lines. Each of the plurality of pixels includes a transistor having a first gate electrode, a semiconductor film over the first gate electrode, and a second gate electrode over the semiconductor film. A portion of the signal-line driver circuit is sandwiched by the gate-line driver circuit and the display region in a direction in which the plurality of gate lines extends. Each of the plurality of gate lines includes a lower gate line and an upper gate line which overlap each other, respectively exist in the same layer as the first gate electrode and the second gate electrode, and are electrically connected to the first gate electrode and the second gate electrode, respectively. The lower gate line and the upper gate line of at least one gate line selected from the plurality of gate lines are electrically connected to each other between the display region and the portion of the signal-line driver circuit. n is a natural number equal to or greater than 5.

An embodiment of the present invention is a display device. The display device includes a substrate, a first gate-line driver circuit, a second gate-line driver circuit, a signal-line driver circuit, a plurality of gate lines, and a plurality of image-signal lines. The substrate includes a display region having a polygonal shape with n vertices and arranged with a plurality of pixels and a frame region surrounding the display region. The first gate-line driver circuit and the second gate-line driver circuit are located over the frame region and sandwich the display region. The signal-line driver circuit is located over the frame region. The plurality of gate lines extends from the first gate-line driver circuit to the second gate-line driver circuit across the display region. The plurality of image-signal lines extends from the signal-line driver circuit to the display region and intersects the plurality of gate lines. Each of the plurality of pixels includes a transistor having a first gate electrode, a semiconductor film over the first gate electrode, and a second gate electrode over the semiconductor film. A first portion of the signal-line driver circuit is sandwiched by the first gate-line driver circuit and the display region in a direction in which the plurality of gate lines extends. A second portion of the signal-line driver circuit is sandwiched by the second gate-line driver circuit and the display region in a direction in which the plurality of gate lines extends. Each of the plurality of gate lines includes a lower gate line and an upper gate line which overlap each other, respectively exist in the same layer as the first gate electrode and the second gate electrode, and are electrically connected to the first gate electrode and the second gate electrode, respectively. The lower gate line and the upper gate line of at least one gate line selected from the plurality of gate lines are electrically connected to each other between the display region and the first portion and between the display region and the second portion. n is a natural number equal to or greater than 5.

### BRIEF DESCRIPTION OF DRAWINGS

FIG. 1 is a schematic top view of a display device according to an embodiment of the present invention.

FIG. 2 is a schematic cross-sectional view of a portion of a display device according to an embodiment of the present invention.

FIG. 3 is a schematic cross-sectional view of a portion of a display device according to an embodiment of the present invention.

FIG. 4 is a schematic cross-sectional view of a portion of a display device according to an embodiment of the present invention.

FIG. 5 is a schematic top view of a portion of a display device according to an embodiment of the present invention.

FIG. 6 is a schematic cross-sectional view of a portion of a display device according to an embodiment of the present invention.

FIG. 7 is a schematic cross-sectional view of a portion of a display device according to an embodiment of the present invention.

FIG. 8 is a schematic top view of a portion of a display device according to an embodiment of the present invention.

FIG. 9 is a schematic cross-sectional view of a portion of a display device according to an embodiment of the present invention.

FIG. 10 is a schematic top view of a portion of a display device according to an embodiment of the present invention.

FIG. 11 is a schematic top view of a portion of a display device according to an embodiment of the present invention.

FIG. 12 is a schematic cross-sectional view of a portion of a display device according to an embodiment of the present invention.

FIG. 13 is a schematic top view of a portion of a display device according to an embodiment of the present invention.

FIG. 14 is a schematic cross-sectional view of a portion of a display device according to an embodiment of the present invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, the drawings are only an example, and do not limit the interpretation of the invention. In the specification and the drawings, the same reference number is provided to an element that is the same as that which appears in preceding drawings, and a detailed explanation may be omitted as appropriate. The reference number is used when plural structures which are the same as or similar to each other are collectively represented, while a hyphen and a natural number are further used when these structures are independently represented.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

In the specification and the claims, an expression “a structure is exposed from another structure” means a mode in which a part of the structure is not covered by the other structure and includes a mode where the part uncovered by the other structure is further covered by another structure. In addition, a mode expressed by this expression includes a mode where a structure is not in contact with other structures.

In the present invention, when one film is processed to form a plurality of films, these films may have different functions and roles. However, these films originate from the film prepared as the same layer by the same process and have substantially the same layer structure, material, and morphology. Hence, the plurality of films is defined as existing in the same layer.

Hereinafter, a display device according to an embodiment of the present invention is explained.

### 1. Overall Structure of Display Device

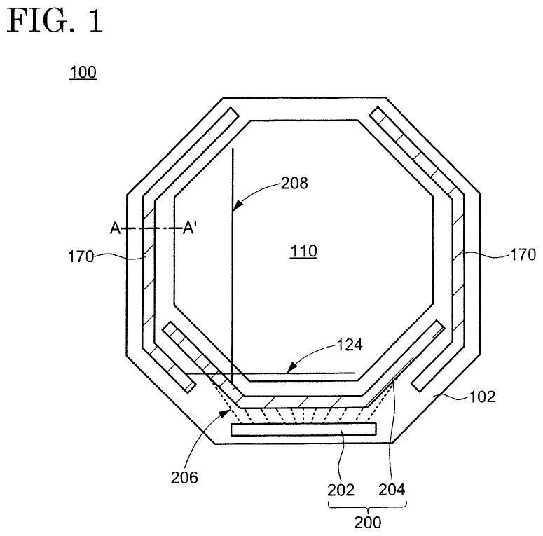

FIG. 1 shows a schematic top view of a display device 100 according to an embodiment of the present invention. The display device 100 has a substrate 102 and a counter substrate which is not illustrated in FIG. 1. The substrate 102 is divided into a display region 110 for displaying images and a frame region surrounding the display region 110. A variety of patterned conductive films, semiconductor films, and insulating films fabricated using photolithography processes is arranged between the substrate 102 and the counter substrate. Appropriate combination of these conductive films, semiconductor films, and insulating films leads to the formation of a plurality of pixels (described below) each including a display element in the display region 110 and a variety of scanning lines and signal lines which is not illustrated in FIG. 1, in addition to driver circuits for driving the pixels as well as a plurality of gate lines 124 and a plurality of image-signal lines 208 for supplying a variety of signals from each driver circuit to the pixels.

The driver circuits include a gate-line driver circuit 170 and a signal-line driver circuit 200. Although two gate-line driver circuits 170 are provided to sandwich the display region 110 in the example demonstrated in FIG. 1, a single gate-line driver circuit 170 may be provided on one side of the display region 110. On the other hand, the signal-line driver circuit 200 includes an analog switch 204 along with an integrated circuit for driving (hereinafter, referred to as a driving IC) 202 connected to the analog switch 204 by lead wirings 206. The driver IC 202 may be structured by combining a variety of conductive films, semiconductor films, and insulating films formed over the substrate 102, or integrated circuits fabricated over a semiconductor substrate may be prepared and mounted over the substrate 102 as the driver IC 202. Power supply and a variety of signals supplied from an external circuit which is not illustrated are supplied to the gate-line driver circuit 170 and the signal-line driver circuit 200, and the gate-line driver circuit 170 and the signal-line driver circuit 200 generate a variety of control signals for controlling the pixels on the basis of these signals. Each gate line 124 extends from the gate-line driver circuit 170 to the display region 110 and supplies the control signals to each pixel to control each pixel. Each gate line 124 may be electrically connected to one gate-line driver circuit 170 or two gate-line driver circuits 170 sandwiching the display region 110. The plurality of image-signal lines 208 extending from the signal-line driver circuit 200 also extends to the display region 110 and intersects the plurality of gate lines 124. The control signals are supplied by the image-signal lines 208 from the signal-line driver circuit 200, thereby supplying the image signals and the like required to display images to each pixel.

Here, as can be understood from FIG. 1, the display region 110 is not a rectangle, but has an n-polygon with five or more vertices. n is a natural number equal to or greater than 4. There is no restriction on the maximum value of n, and the maximum value of n may be selected from a range equal to or greater than 8 and equal to or less than 12, for example. The shape of the display region 110 does not necessarily have to be a regular n-polygon, and a length of at least one of the sides may be different from a length of any of the other sides. The display device 100 can be suitably used for head-mounted VR goggles and the like because the display region 110 has such an irregularly shaped display region to enable nearly circular display. Note that the substrate 102 may have a rectangular shape or a m-polygonal shape with five or more vertices similar to the display region 110. m is a natural number equal to or greater than 5, and its maximum value may also be selected from a range equal to or greater than 8 and equal to or less than 12, for example. The vertex of the display region 110 does not necessarily have to be a vertex formed by the intersection of two straight lines and may be rounded. Similarly, the vertices of the substrate 102 may be chamfered. The irregular shape of the substrate 102 enables the entire display device 100 to be downsized, which allows the display device 100 to be suitably used in head-mounted VR goggles and the like. In addition, the irregular shape of the substrate 102 matching the display region 110 increases the area (occupancy ratio) occupied by the display region 110 relative to the overall area of the display device 100, enabling production of larger images while downsizing the VR goggles. As a result, VR goggles capable of reproducing a field of view closer to reality can be provided.

Since the display region 110 has an irregular shape, the gate-line driver circuit 170 is bent along the contour of the display region 110. In the example shown in FIG. 1, each gate-line driver circuit 170 is arranged to have two bending points. Similarly, the signal-line driver circuit 200 is also bent along the contour of the display region 110. In the example demonstrated in FIG. 1, a portion of the signal-line driver circuits 200, e.g., the analog switch 204, is arranged to have two bending points. In addition, a portion of the signal-line driver circuit 200 is located between the gate-line driver circuit 170 and the display region 110 in the direction in which the gate lines 124 extend. In the example shown in FIG. 1, a portion of the signal-line driver circuit 200 is located between the display region 110 and one of the gate-line driver circuits 170 in the direction in which the gate lines 124 extend, another portion is positioned between the display region 110 and the other of the gate-line driver circuits 170, and the remaining portion is located at a position which is not sandwiched between the two gate-line driver circuits 170. Hereinafter, each of the above-described components is described in detail.

### (1) Substrate and Counter Substrate

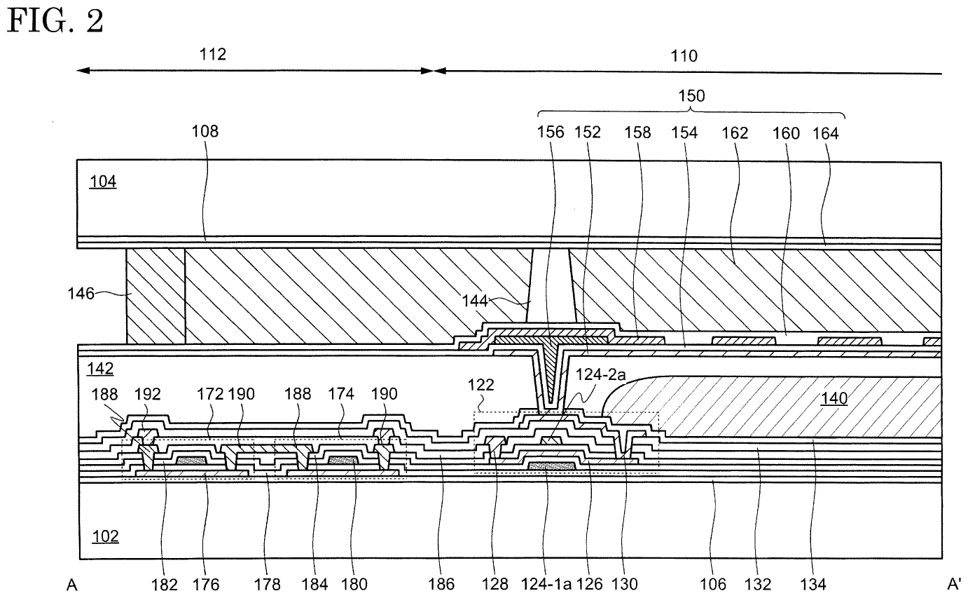

FIG. 2 shows a schematic cross-sectional view along the chain line A-A′ of FIG. 1. FIG. 2 shows a schematic cross-sectional view of the gate-line driver circuit 170 as well as one pixel provided in the display region 110 and including a liquid crystal element as a display element. When a liquid crystal element is used as a display element, a backlight which is not illustrated is provided. Since known light sources (e.g., cold cathode tube, light-emitting diode, and the like) can be used as the backlight as appropriate, the description thereof is omitted.

The substrate 102 and the counter substrate 104 face each other and are configured to provide physical strength to the display device 100 and to transmit visible light emitted from the backlight which is not illustrated. For example, a substrate having a light-transmitting property, such as a glass substrate and a quartz substrate, is used as the substrate 102 and the counter substrate 104. The substrate 102 and the counter substrate 104 may include a polymer having a light-transmitting property, such as a polyimide, a polyamide, a polycarbonate, an acrylic resin, and a polysiloxane. At least one of the substrate 102 and the counter substrate 104 may be flexible.

### (2) Driver Circuit

At least a portion of the gate-line driver circuit 170 and the signal-line driver circuit 200 is formed by appropriately combining a variety of patterned conductive films, semiconductor films, and insulating films fabricated over the substrate 102. There are no restrictions on the configuration of these driver circuits, and the gate-line driver circuit 170 and the signal-line driver circuit 200 may be configured using a plurality of transistors, capacitive elements, and the like. In the example shown in FIG. 1, two transistors 172 and 174 connected to each other are shown as a part of the elements constituting the gate-line driver circuit 170.

Specifically, the transistors 172 and 174 are provided in the frame region either directly over the substrate 102 or over an undercoat 106 which is an optional component. There are no restrictions on the configuration of the transistors 172 and 174, and any known structure can be applied as appropriate. In the example demonstrated in FIG. 2, the transistors 172 and 174 each have a semiconductor film 176, a first insulating film 178 over the semiconductor film 176, a gate electrode 180 located over the first insulating film 178 and overlapping the semiconductor film 176, a second insulating film 182 and a third insulating film 184 covering the gate electrode 180, and terminals 188 and 190 electrically connected to the semiconductor film 176 through openings formed in the second insulating film 182 and the third insulating film 184. A wiring 192 for supplying the transistors 172 and 174 with signals from an external circuit is connected to the terminals 188 and 190. The first insulating film 178 serves as a gate insulating film for the transistors 172 and 174. The terminal 190 of the transistor 172 and the terminal 188 of the transistor 174 are integrated, thereby electrically connecting the transistors 172 and 174. There are no restrictions on the material structuring the semiconductor film 176, and the material may be a Group 14 element such as silicon or may contain an oxide of a Group 13 element such as gallium and indium. When the semiconductor film 176 contains silicon, there is also no restriction on its crystallinity, and the semiconductor film 176 may be amorphous or polycrystalline. For example, the formation of the semiconductor film 176 with polysilicon allows the formation of the driver circuits capable of high-speed operation.

### (3) Pixel

Each pixel is composed of a display element 150 and a pixel circuit for operating the display element 150 on the basis of the control signals supplied by the gate-line driver circuit 170 and the signal-line driver circuit 200. There are no restrictions on the configuration of the pixel circuit, and the pixel circuit may be formed by combining one or a plurality of transistors and one or a plurality of capacitance elements as appropriate. There are also no restrictions on the configuration of the display element 150 and the display mechanism. Therefore, the display element 150 may be a liquid crystal element or an electroluminescence element. In the example shown in FIG. 2, a driving transistor 122 electrically connected to the display element 150 and a liquid crystal element functioning as the display element 150 are illustrated.

The driving transistor 122 includes a first gate electrode 124-1a provided over the first insulating film 178, a second insulating film 182 covering the first gate electrode 124-1a, a semiconductor film 126 located over the second insulating film 182 and overlapping the first gate electrode 124-1a, a third insulating film 184 over the semiconductor film 186, a second gate electrode 124-2a located over the third insulating film 184 and overlapping the first gate electrode 124-1a and the semiconductor film 126, a fourth insulating film 186 covering the second gate electrode 124-2a, a terminal 128 electrically connected to the semiconductor film 126 through an opening formed in the fourth insulating film 186, a fifth insulating film 132 over the terminal 128 and the fourth insulating film 186, a terminal 130 electrically connected to the semiconductor film 126 through an opening formed in the fourth insulating film 186 and the fifth insulating film 132, and the like. The first gate electrode 124-1a exists in the same layer as the gate electrode 180, while the second gate electrode 124-2a exists in the same layer as the terminals 188 and 190. In addition, the first gate electrode 124-1a and the second gate electrode 124-2a constitute a part of the gate line 124. As described below, the first gate electrode 124-1a and the second gate electrode 124-2a are electrically connected and have the same potential as each other. The second insulating film 182 and the third insulating film 184 are shared by the transistors 172 and 174 and the like of the gate-line driver circuit 170, and both serve as gate insulating films of the driving transistor 122. The terminal 130 is electrically connected to the display element 150. hence, the image signals input to the terminal 128 from the signal-line driver circuit 200 through the image-signal line 208 are input to the display element 150 via the semiconductor film 126 and the terminal 130 when the driving transistor 122 is on.

There is also no restriction on the material contained in the semiconductor film 126, and a Group 14 element such as silicon is exemplified. In this case, there is also no restriction on the crystallinity of the semiconductor film 126, and the semiconductor film 126 may be amorphous or polycrystalline.

Alternatively, the semiconductor film 126 may contain an oxide semiconductor of a Group 13 element such as gallium and indium. The oxide semiconductor may contain a plurality of different Group 13 elements, where indium-gallium oxide (IGO) is represented as an example. The oxide semiconductor may further contain a Group 12 element. A typical oxide semiconductor containing a Group 12 element includes indium-gallium-zinc oxide (IGZO). The semiconductor film 126 may also contain other elements and may include a Group 14 element such as tin and a Group 4 element such as titanium and zirconium.

A leveling film 142 is provided over the gate-line driver circuit 170 and the pixel circuit including the driving transistor 122. At this time, a sixth insulating film 134 may be disposed under the leveling film 142. The leveling film 142 absorbs the unevenness caused by the transistors 172 and 174 and the driving transistor 122, resulting in a flat surface. Note that the display region 110 shown in FIG. 2 has a so-called color filter-on-array structure, in which a color filter 140 is provided between the display element 150 and the substrate 102 (specifically, between the leveling film 142 and the fifth insulating film 132 (or between the leveling film 142 and the sixth insulating film 134)).

Since each of the above-described components forming the driver circuits and the pixel circuit can be formed using known materials, a detailed description is omitted. In brief, each of the undercoat 106, the first insulating film 178, the second insulating film 182, the third insulating film 184, the fourth insulating film 186, the fifth insulating film 132, and the sixth insulating film 134 may be formed with one or a plurality of films containing a silicon-containing inorganic compound such as silicon oxide and silicon nitride. The gate electrode 180, the terminals 188 and 190, the first gate electrode 124-1a, the second gate electrode 124-2a, the terminal 128, and the like may be composed of a metal such as titanium, molybdenum, tungsten, and copper or an alloy containing one or a plurality of these metals. The terminal 130 as well as the pixel electrode 152 and the common electrode 158 described below are formed with a transparent conductive film such as a film of indium-tin oxide (ITO), for example. The leveling film 142 may be formed with a polymer such as an acrylic resin, an epoxy resin, a silicon resin, and a polyimide resin. The color filter 140 may be composed of the aforementioned polymer and a pigment.

When the display element 150 is a liquid crystal element, the display element 150 is composed of a pixel electrode 152 electrically connected to the driving transistor 122, a common electrode 158 over the pixel electrode 152, an inter-electrode insulating film 154 located between the pixel electrode 152 and the common electrode 158 to insulate the pixel electrode 152 and the common electrode 158, a first orientation film 160 and a second orientation film 164 over the pixel electrode 152, a liquid crystal layer 162 between the first orientation film 160 and the second orientation film 164, and the like as shown in FIG. 2. As an optional component, an auxiliary wiring 156 may be provided under or over the common electrode 158 to prevent a voltage drop of the common electrode 158.

The substrate 102 and the counter substrate 104 are secured to each other by a sealant 146, and the liquid crystal layer 162 is injected into the space formed by the sealant 146, the substrate 102, and the counter substrate 104. The liquid crystal layer 162 may be provided with a spacer 144 to maintain the thickness of the liquid crystal layer 162. The spacer 144 may be formed in a columnar shape as shown in FIG. 2, or spherical spacers may be dispersed in the liquid crystal layer 162 although not illustrated. As an optional component, an overcoat 108 in contact with the counter substrate 104 may be provided. The overcoat 108 may also be composed of one or a plurality of films containing a silicon-containing inorganic compound.

Although the liquid crystal element shown in FIG. 2 is a so-called IPS (In-Plane Switching) type liquid crystal element, there are no restrictions on the driving mode of the display element. The liquid crystal element may be a TN (Twisted Nematic) type liquid crystal element or a VA (Vertical Alignment) type liquid crystal element. Since each component structuring the liquid crystal element may also be formed using known structures, an explanation is omitted.

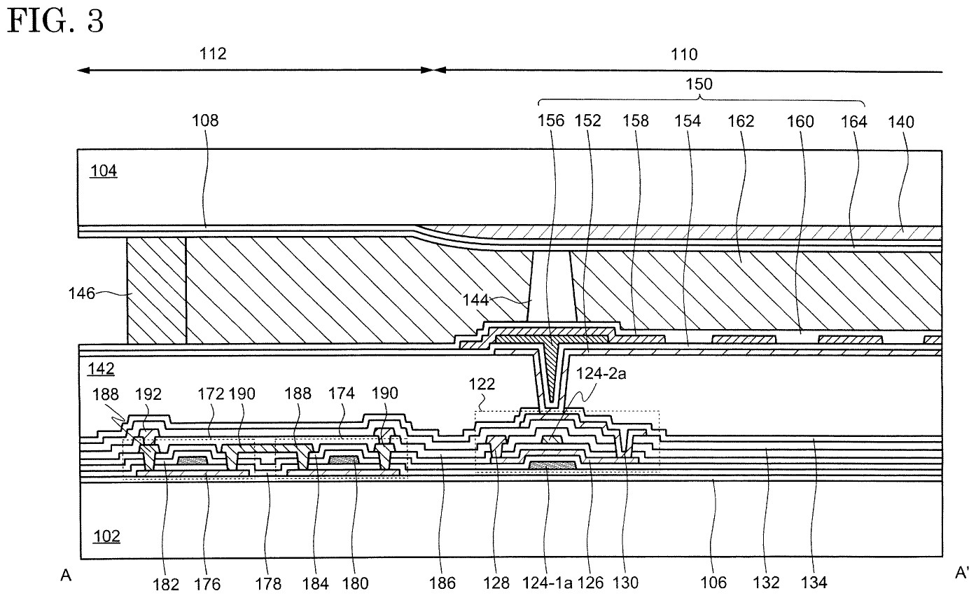

Furthermore, the color filter may not be arranged on the substrate 102 side, but may be arranged on the side of the counter substrate 104. Specifically, the color filter 140 may be provided so as to be in contact with the counter substrate 104, and the overcoat 108 may be formed to cover the color filter 140 as shown in FIG. 3.

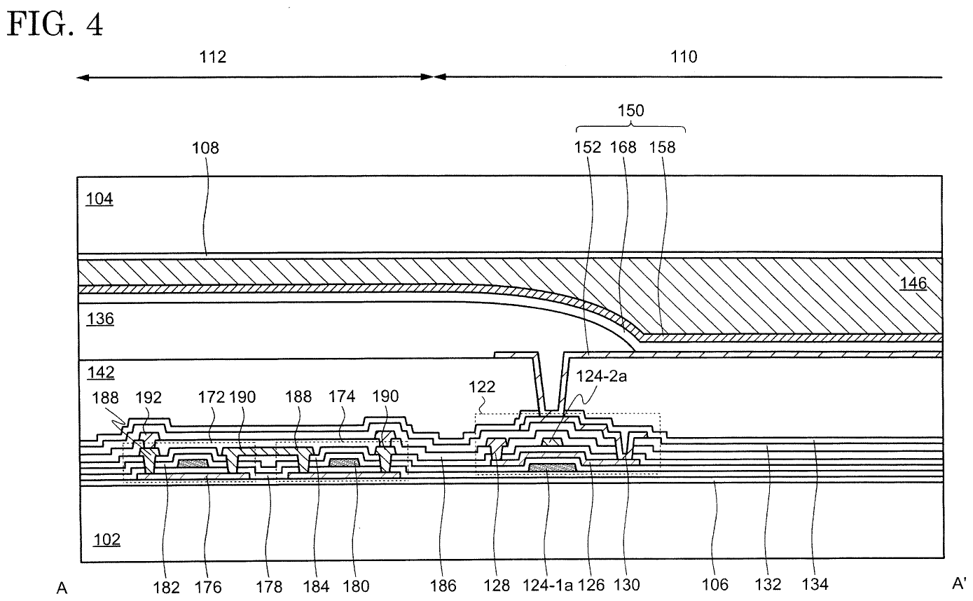

Alternatively, the display element 150 may be an electroluminescence element. In this case, an insulating partition wall 136 may be provided to cover the edge portion of the pixel electrode 152 and the opening formed in the leveling film 141 and the like to connect the pixel electrode 152 and the terminal 130, and an electroluminescence layer 168 may be fabricated between the pixel electrode 152 and the common electrode 158 as shown in FIG. 4. The structure of the electroluminescence layer 168 may also be arbitrarily determined, and the electroluminescence layer 168 may be formed by combining functional layers such as a charge-injection layer, a charge-transporting layer, a charge-blocking layer, an emission layer, and an exciton-blocking layer as appropriate. The electroluminescence element may be a bottom-emission type element or a top-emission type element. A sealant 146, which also functions as a protective film, is provided between the common electrode 158 and the counter substrate 104. Examples of the sealant 146 include a layer containing a silicon-containing inorganic compound such as silicon nitride, a layer containing a resin such as an acrylic resin and an epoxy resin, or a laminate thereof.

### 2. Structure of Gate Line

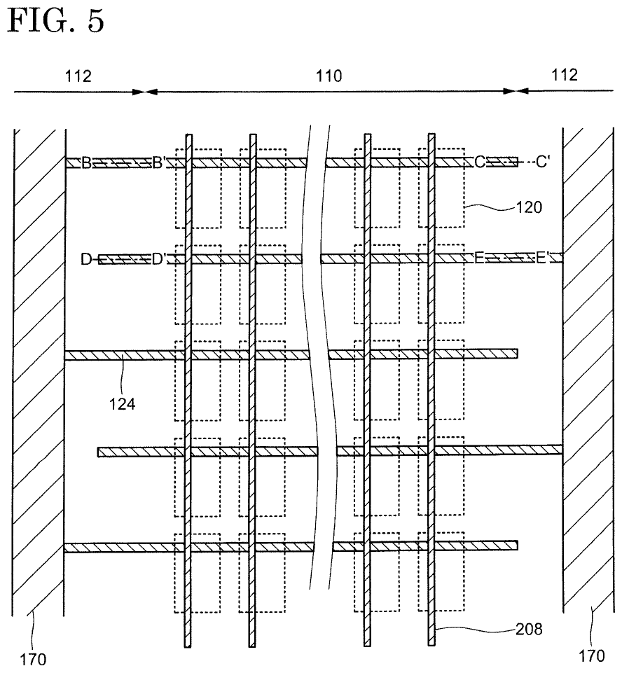

FIG. 5 shows a schematic top view of a portion of the display device 100. FIG. 5 shows a pair of gate-line driver circuits 170 provided in the frame region as well as the plurality of pixels 120 electrically connected thereto. The pixels 120 are arranged to form a plurality of rows and columns. In the example shown in FIG. 5, the so-called one-sided power-feeding mode is employed, where each of the plurality of gate lines 124 is arranged to extend from one of the pair of gate-line driver circuits 170 in the row direction and across the display region 110 but is not connected to the other gate-line driver circuit. The power-feeding direction is switched from row to row. Therefore, when one gate line 124 is connected to one gate-line driver circuit 170 and a gate signal, which is one of the control signals, is supplied from that gate-line driver circuit 170, the gate lines 124 adjacent to this gate line 124 in the column direction are all connected to the other gate-line driver circuit 170 to be supplied with the gate signal.

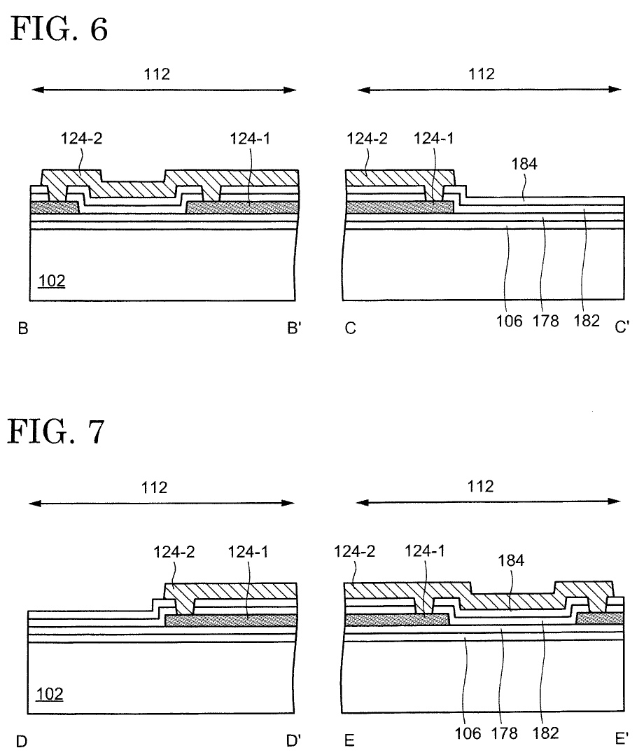

Here, each gate line 124 is composed of a lower gate line and an upper gate line existing in different layers and respectively located in two layers overlapping each other in the normal direction of the substrate 102. Specifically, as shown in FIG. 6 including schematic views of the cross sections along the chain lines B-B′ and C-C′ of FIG. 5, each gate line 124 is composed of a lower gate line 124-1 and an upper gate line 124-2. Both the lower gate line 124-1 and the upper gate line 124-2 traverse the display region 110 and are electrically connected to the first gate electrode 124-1a and the second gate electrode 124-2a, respectively. In other words, the first gate electrode 124-1a and the lower gate line 124-1 exist in the same layer, and the first gate electrode 124-1a constitutes a portion of the lower gate line 124-1. Similarly, the second gate electrode 124-2a and the upper gate line 124-2 exist in the same layer, and the second gate electrode 124-2a constitutes a portion of the upper gate line 124-2.

Moreover, the lower gate line 124-1 and the upper gate line 124-2 are electrically connected to each other in the frame region 112. More specifically, the lower gate line 124-1 and the upper gate line 124-2 are electrically connected to each other in the frame region 112 on the side of the gate-line driver circuit 170 to which this gate line 124 is connected and in the frame region 112 on the opposite side of this gate-line driver circuit 170-2 with respect to the display region 110. Thus, the first gate electrode 124-1a and the second gate electrode 124-2a are electrically connected and exist in equipotential with each other. The electrical connection between the lower gate line 124-1 and the upper gate line 124-2 is performed through openings formed in the insulating films formed therebetween (in the example shown in FIG. 6, the second insulating film 182 and the third insulating film 184). Since the example shown in FIG. 6 employs the one-sided power-feeding mode, focusing on two gate lines 124 adjacent to each other in the column direction, one gate line 124 receives the gate signal from one of the gate-line driver circuits 170, and the lower gate line 124-1 and the upper gate line 124-2 are electrically connected in the frame region 112 on both sides of the display region 110. On the other hand, as shown in FIG. 7, including schematic views of the cross sections along the chain lines D-D′ and E-E′ of FIG. 5, the other gate line 124 receives the gate signal from the other gate-line driver circuit 170, and the lower gate line 124-1 and the upper gate line 124-2 are electrically connected in the frame region 112 on both sides to the display region 110.

Furthermore, the lower gate line 124-1 is not continuous from the display region 110 to the gate-line driver circuit 170 in the frame region 112, but is divided into two fraction wirings (see the cross sections of B-B′ in FIG. 6 and E-E′ in FIG. 7). One fraction wiring (the lower gate line 124-1 on the left side in the cross section of B-B′ in FIG. 6) is connected to the gate-line driver circuit 170, while the other fraction wiring (the lower gate line 124-1 in both cross sections in FIG. 6) traverses the display region 110. The two fraction wirings are electrically connected via the upper gate line 124-2. The electrical connection between these two fraction wirings and the upper gate line 124-2 is also performed through openings formed in the insulating films provided therebetween (in the example shown in FIG. 6 and FIG. 7, the second insulating film 182 and the third insulating film 184).

As described above, the gate line 124 is branched into the lower gate line 124-1 and the upper gate line 124-2 in the frame region 112, and the gate signals are supplied using the branched lower gate line 124-1 and upper gate line 124-2 in the display device 100. Furthermore, the connection of the lower gate line 124-1 and the upper gate line 124-2 is performed at two locations sandwiching the display region 110. Employment of this configuration enables a large cross-sectional area of the gate line 124 to be secured within the display region 110. Hence, it is possible to reduce the electrical resistance of the gate line 124 and prevent the increase in time constant. As a result, delays of the gate signals can be prevented. In addition, the pixel circuit provided in the display region 110 and the gate-line driver circuit 170 can be insulated until the formation of the upper gate line 124-2 by dividing the lower gate line 124-1 into two fraction wirings. Therefore, it is possible to discharge the charge accumulated during the manufacturing of the display device 100 to the gate-line driver circuit 170, thereby remarkably reducing the probability of electrostatic breakdown of the pixel circuit.

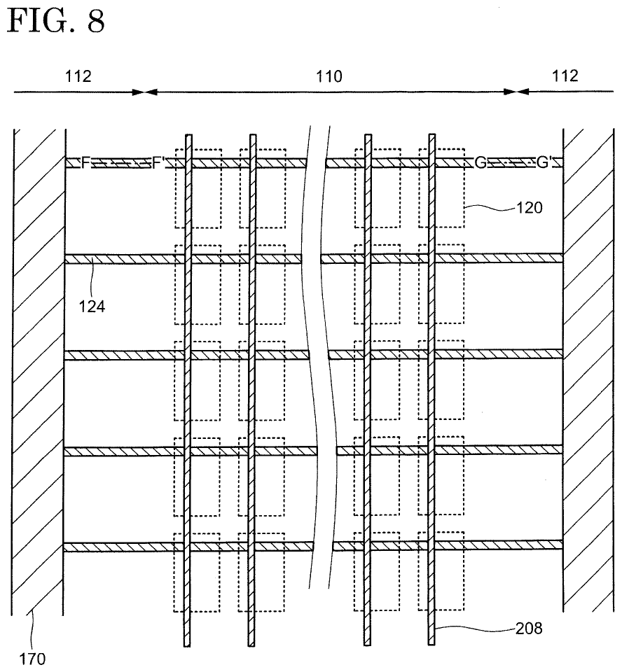

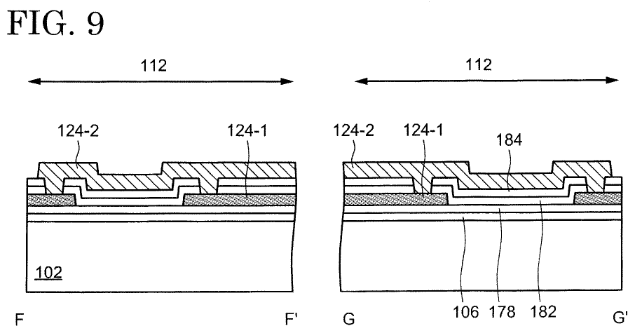

The both-sided power-feeding mode can also be employed in the display device 100 in place of the one-sided power-feeding mode. In this case, each of the gate lines 124 is connected to the pair of gate-line driver circuits 170 sandwiching the display region 110 as shown in FIG. 8 and receives the gate signals from the pair of gate-line driver circuits 170. In this mode, the gate line 124 is also composed of the lower gate line 124-1 and the upper gate line 124-2 electrically connected to each other in the frame region 112. More specifically, as shown in FIG. 9 including schematic views of the cross sections along the chain lines F-F′ and G-G′ of FIG. 8, the gate line 124 is branched into the lower gate lines 124-1 and the upper gate lines 124-2 at two locations sandwiching the display region 110 and located in the frame region 112, and both the lower gate line 124-1 and the upper gate line 124-2 traverse the display region 110. The electrical connection of the lower gate line 124-1 and the upper gate line 124-2 is performed through openings in the insulating films formed therebetween (in the example shown in FIG. 9, the second insulating film 182 and the third insulating film 184).

The lower gate line 124-1 is also divided in the frame region 112. That is, the lower gate line 124-1 is divided into a first fraction wiring traversing the display region 110 (lower gate line 124-1 in both cross-sectional views of FIG. 9), a second fraction wiring located between the first fraction wiring and one of the gate-line driver circuits 170 and connected to the one of the gate-line driver circuits 170 (lower gate line 124-1 on the left side in the cross-sectional view of F-F′ in FIG. 9), and a third fraction wiring located between the first fraction wiring and the other of the gate-line driver circuits 170 and connected to the other of the gate-line driver circuits 170 (lower gate line 124-1 on the right side in the cross-sectional view of G-G′ in FIG. 9). The first fraction wiring and the second fraction wiring are electrically connected by the upper gate line 124-2, and similarly, the first fraction wiring and the third fraction wiring are also electrically connected by the upper gate line 124-2. The electrical connections between the first fraction wiring and the second fraction wiring and the electrical connection between the first fraction wiring and the third fraction wiring are also performed through openings in the insulating films formed therebetween (in the example shown in FIG. 9, the second insulating film 182 and the third insulating film 184).

3. Connection of Gate Wiring and Relationship with Image-Signal Line

As described above, the shapes of the substrate 102 and the counter substrate 104 may be set to conform to the shape of the display region 110 in the display device 100. Thus, on the side where the signal-line driver circuit 200 is provided, for example, the corners of the substrate 102 and the counter substrate 104 may be cut off to provide not only a display device with a more circular shape but also a display device with a higher occupancy of the display region 110. However, when such a shape is adopted, it becomes difficult to linearly arrange the gate-line driver circuits 170, and the partly bent gate-line driver circuits 170 are arranged as shown in FIG. 1. In addition, a portion of the signal-line driver circuit 200 such as an analog switch 204 is also arranged to be partially bent to conform to the shapes of the substrate 102 and the display region 110. Therefore, it is possible to downsize the display device 100 by arranging a portion of the signal-line driver circuit 200 such as the analog switch 204 so as to be sandwiched between the display region 110 and the gate-line driver circuit 170 in the direction in which the gate line 124 extends.

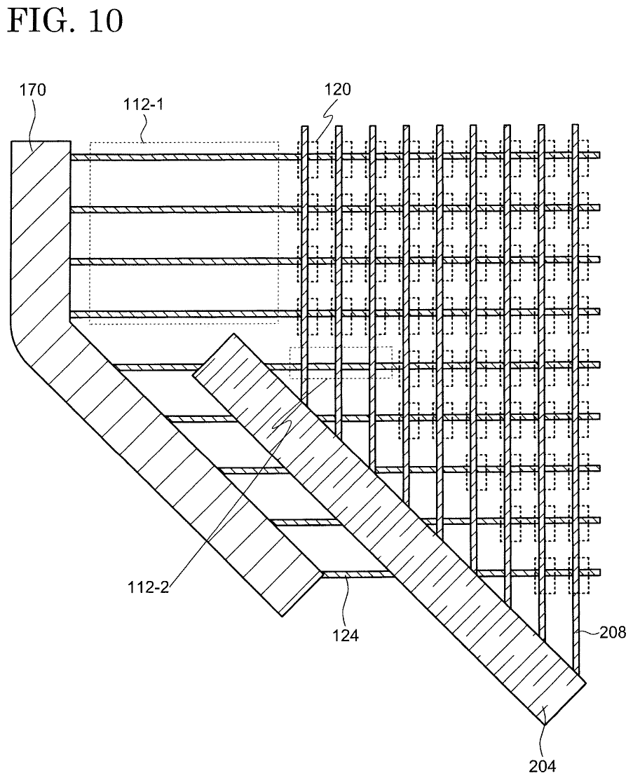

When adopting such an arrangement, the connection portion of the lower gate line 124-1 including the fraction wirings with the upper gate line 124-2 can be arbitrarily arranged in the frame region 112-1 in which any portion of the signal-line driver circuit 200 does not exist between the display region 110 and the gate-line driver circuit 170 as schematically shown in FIG. 10, without considering the arrangement of the image-signal lines 208 formed in the upper layer than the gate lines 124. On the other hand, in the frame region 112-2 where a part of the signal-line driver circuit 200 exists between the display region 110 and the gate-line driver circuit 170, the lower gate line 124-1 and the upper gate line 124-2 are connected in a region where the image-signal lines 208 are arranged, Therefore, when the pitch of the image-signal lines 208 is small and the image-signal lines 208 are arranged in high density, a short circuit between or disconnection of the image-signal lines 208 may occur if a misalignment occurs in the photolithography processes for manufacturing the display device 100.

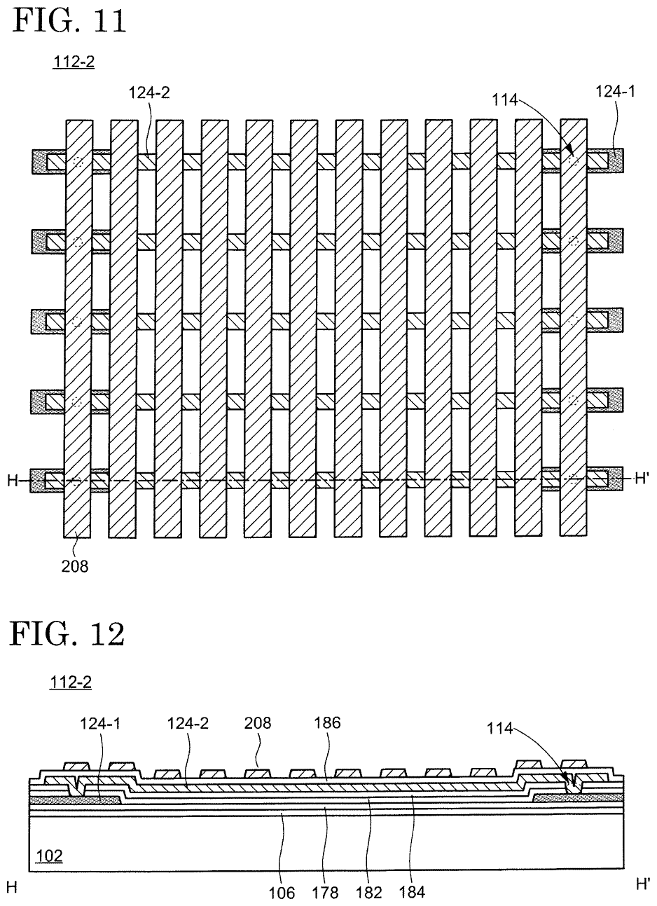

Therefore, in the frame region 112-1, the connection of the lower gate line 124-1 and the upper gate line 124-2 is performed at a position overlapping the image-signal line 208 as shown in the schematic top view of FIG. 11 and the schematic view of the cross section along the chain line H-H′ (FIG. 12). In other words, the opening 114 provided in a plurality of insulating films (e.g., the second insulating film 182 and the third insulating film 184) for the electrical connection between the lower gate line 124-1 and the upper gate line 124-2 is formed so that the entirety thereof overlaps one image-signal line 208. Alternatively, when the lower gate line 124-1 and the upper gate line 124-2 are in direct contact with each other in this opening 114, the electrical connection between the lower gate line 124-1 and the upper gate line 124-2 is performed so that the entire contact surface thereof overlaps one image-signal line 208. Therefore, the opening 114 does not overlap a region between adjacent image-signal lines 208. This arrangement prevents a short circuit between adjacent image-signal lines 208 because, even if the opening 114 is displaced, the image-signal lines 208 which do not overlap the opening 114 are not affected. For example, if misalignment or variation in the processed shape causes the opening 114 to be formed near the image-signal line 208 adjacent to the image-signal line 208 overlapping the opening 114, an abnormality may occur in the resist shape used to form the image-signal lines 208. If such an abnormality occurs, the intended patterning becomes difficult and adjacent image-signal lines 208 may short-circuit each other. Furthermore, if the image-signal line 208 is not formed to cover the entire opening 114, the image-signal lines 208 partially overlapping the opening 114 may not be formed with sufficient width, or the opening 114 may cause a disconnection thereof. However, such defects can be prevented even when the image-signal lines 208 are arranged at high density by forming the opening 114 so that its entirety overlaps one image-signal line 208.

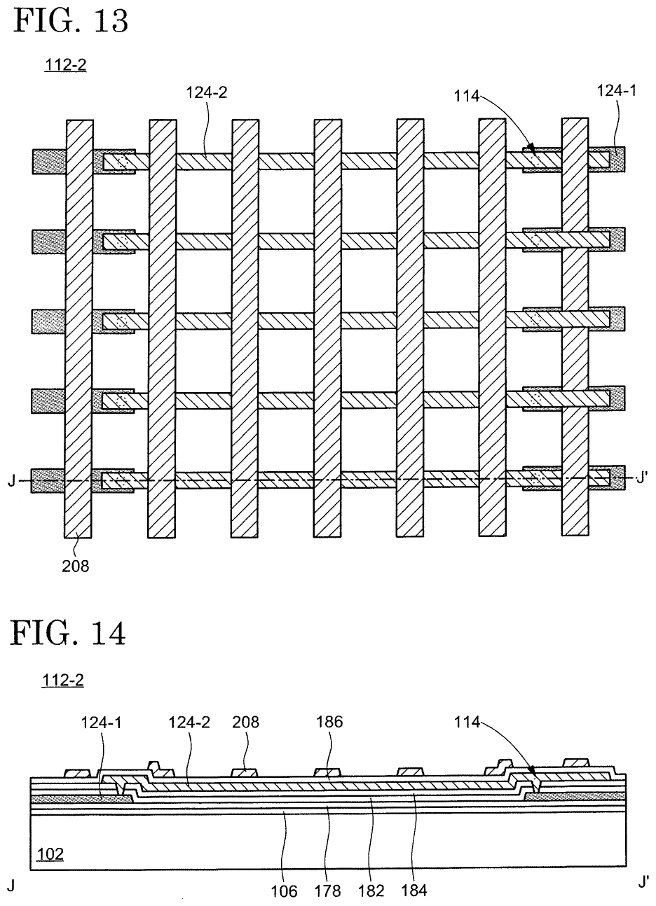

Note that, when the pitch of the image-signal lines 208 is large and the arrangement density is not high, the opening 114 may be formed between adjacent image-signal lines 208 to electrically connect the lower gate line 124-1 and the upper gate line 124-2. Specifically, as shown in FIG. 13 and the schematic view of the cross section along the chain line J-J′ thereof (FIG. 14), the opening 114 is formed so as to be exposed from the plurality of image-signal lines 208. In other words, the lower gate lines 124-1 and the upper gate lines 124-2 are electrically connected so that the opening 114 or the entire contact surface between the lower gate line 124-1 and the upper gate line 124-2 does not overlap any of the image-signal lines 208. This arrangement prevents disconnection of the image-signal lines 208 even when the opening 114 is displaced.

As described above, in the display device 100 according to an embodiment of the present invention, the gate-line driver circuit 170 and the signal-line driver circuit 200 may be bent to fit the irregularly shaped display region 110, and a portion of the signal-line driver circuit 200 may be placed between the gate-line driver circuit 170 and the display region 110. This configuration allows the substrate 102 and the counter substrate 104 to be downsized, thus providing a downsized display device having a higher occupancy of the display region 110. In addition, the gate line 124 is branched into the lower gate lines 124-1 and the upper gate lines 124-2 in the frame region 112, and both the lower gate lines 124-1 and upper gate lines 124-2 traverse the display region 110 and are electrically connected to each other in the frame region 112 on both sides of the display region 110. Hence, an increase in the wiring resistance of the gate lines 124 is prevented, and the resistance increase of the gate lines 124 and the resulting increase in the time constant can be prevented even if the number of pixels 120 in each row increases. These characteristics allows the production of a display device having a large number of pixels, i.e., a downsized display device with a high-resolution by implementing an embodiment of the present invention. Furthermore, each of the openings 114 for electrical connection between the lower gate line 124-1 and the upper gate line 124-2 is provided so that the entire opening 114 overlaps one image-signal line 208 or is exposed from the adjacent image-signal lines 208. Therefore, the influence of misalignment during the formation of the openings on the image-signal lines 208 can be reduced, and a short circuit and disconnection of the image-signal lines 208 can be prevented even when the image-signal lines 208 are arranged in high density. It can be said that these features also contribute to the increase in resolution and improvement of the yield of display devices.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of each embodiment is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. A display device comprising:
a substrate having a display region having a polygonal shape with n vertices and arranged with a plurality of pixels and a frame region surrounding the display region;
a gate-line driver circuit and a signal-line driver circuit over the frame region;
a plurality of gate lines extending from the gate-line driver circuit to the display region; and
a plurality of image-signal lines extending from the signal-line driver circuit to the display region and intersecting the plurality of gate lines,
wherein each of the plurality of pixels comprises a transistor comprising a first gate electrode, a semiconductor film over the first gate electrode, and a second gate electrode over the semiconductor film,
a portion of the signal-line driver circuit is sandwiched by the gate-line driver circuit and the display region in a direction in which the plurality of gate lines extends,
each of the plurality of gate lines comprises a lower gate line and an upper gate line which overlap each other, respectively exist in the same layer as the first gate electrode and the second gate electrode, and are electrically connected to the first gate electrode and the second gate electrode, respectively,
the lower gate line and the upper gate line of at least one gate line selected from the plurality of gate lines are electrically connected to each other between the display region and the portion of the signal-line driver circuit, and
n is a natural number equal to or greater than 4.

2. The display device according to claim 1,
wherein a contact surface of the lower gate line and the upper gate line overlaps one of the plurality of image-signal lines.

3. The display device according to claim 1,
wherein a contact surface of the lower gate line and the upper gate line is exposed from the plurality of image-signal lines.

4. The display device according to claim 1,
wherein the lower gate line of the at least one gate line is divided into two fraction wirings between the display region and the portion of the signal-line driver circuit, and
the two fraction wirings are electrically connected to each other through the upper gate line between the display region and the portion of the signal-line driver circuit.

5. The display device according to claim 4,
wherein a contact surface of the fraction wiring and the upper gate line overlaps one of the plurality of image-signal lines.

6. The display device according to claim 4,
wherein a contact surface of the fraction wiring and the upper gate line is exposed from the plurality of image-signal lines.

7. The display device according to claim 1,
wherein the lower gate line and the upper gate line of the at least one gate line are further electrically connected to each other over the frame region opposite to the gate-line driver circuit and between the display region and the portion of the signal-line driver circuit.

8. The display device according to claim 1,
wherein the portion of the signal-line driver circuit includes an analogue switch.

9. The display device according to claim 1,
wherein the gate-line driver circuit is bent along a contour of the display region.

10. The display device according to claim 1,
wherein the substrate has a polygonal shape with m vertices, and
m is a natural number equal to or greater than 5.

11. A display device comprising:
a substrate having a display region having a polygonal shape with n vertices and arranged with a plurality of pixels and a frame region surrounding the display region;
a first gate-line driver circuit and a second gate-line driver circuit located over the frame region and sandwiching the display region;
a signal-line driver circuit over the frame region;
a plurality of gate lines extending from the first gate-line driver circuit to the second gate-line driver circuit across the display region; and
a plurality of image-signal lines extending from the signal-line driver circuit to the display region and intersecting the plurality of gate lines,
wherein each of the plurality of pixels comprises a transistor comprising a first gate electrode, a semiconductor film over the first gate electrode, and a second gate electrode over the semiconductor film,
a first portion of the signal-line driver circuit is sandwiched by the first gate-line driver circuit and the display region in a direction in which the plurality of gate lines extends,
a second portion of the signal-line driver circuit is sandwiched by the second gate-line driver circuit and the display region in a direction in which the plurality of gate lines extends,
each of the plurality of gate lines comprises a lower gate line and an upper gate line which overlap each other, respectively exist in the same layer as the first gate electrode and the second gate electrode, and are electrically connected to the first gate electrode and the second gate electrode, respectively,
the lower gate line and the upper gate line of at least one gate line selected from the plurality of gate lines are electrically connected to each other between the display region and the first portion and between the display region and the second portion, and
n is a natural number equal to or greater than 4.

12. The display device according to claim 11,
wherein a contact surface of the lower gate line and the upper gate line overlaps one of the plurality of image-signal lines.

13. The display device according to claim 11,
wherein a contact surface of the lower gate line and the upper gate line is exposed from the plurality of image-signal lines.

14. The display device according to claim 1,
wherein the lower gate line of the at least one gate line is divided into a first fraction wiring extending across the display region, a second fraction wiring between the first fraction wiring and the first gate-line driver circuit, and a third fraction wiring between the first fraction wiring and the second gate-line driver circuit, and
the second fraction wiring and the third fraction wiring are electrically connected to the first fraction wiring through the upper gate line between the display region and the first portion and between the display region and the second portion, respectively.

15. The display device according to claim 14,
wherein a contact surface of the second fraction wiring and the upper gate line overlaps one of the plurality of image-signal lines.

16. The display device according to claim 14,
wherein a contact surface of the second fraction wiring and the upper gate line is exposed from the plurality of image-signal lines.

17. The display device according to claim 14,
wherein a contact surface of the third fraction wiring and the upper gate line overlaps one of the plurality of image-signal lines.

18. The display device according to claim 14,
wherein a contact surface of the third fraction wiring and the upper gate line is exposed from the plurality of image-signal lines.

19. The display device according to claim 11,
wherein the first portion and the second portion each include an analogue switch.

20. The display device according to claim 11,
wherein the first gate-line driver circuit and the second gate-line driver circuit are each bent along a contour of the display region.
